(19) United States
(12) Patent Application Publication
(10) Pub. No.: US 2012/0060437 A1
(43) Pub. Date: Mar. 15, 2012

(54) Building Structure

(76) Inventor: Chuck McCune, Albuquerque, NM (US)

(21) Appl. No.: 13/100,476

(22) Filed: May 4, 2011

Related U.S. Application Data
(60) Provisional application No. 61/331,281, filed on May 4, 2010.

(51) Int. Cl. E04B 1/00; E06B 1/04; E04C 2/284; E04B 1/38

(52) U.S. Cl. 52/204.1; 52/578; 52/588.1; 52/794.1; 52/745.21; 52/745.06

(57) ABSTRACT

A building structure. A plurality of vertically upright wall panels enclose a defined space. The wall panels are linked together to form a stable structure. A plurality of roof panels cover the enclosed space and are affixed to the wall panels.

### CROSS-REFERENCE TO RELATED APPLICATIONS

This application claims priority to and the benefit of the filing of U.S. Provisional Patent Application Ser. No. 61/331,281, entitled “VERTEX BUILDING SYSTEM”, filed on May 4, 2010, and the specification and claims thereof are incorporated herein by reference.

### COPYRIGHTED MATERIAL

©2010 Chuck McCune. A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The present invention relates to building construction methods and structural components.

2. Description of Related Art

Setting up buildings is inherently time consuming, expensive, and dangerous. In the aftermath of disasters, response time is of utmost concern, high cost translates into limited response in providing significant disaster resistant structures, and adverse conditions in a disaster area contributes in many ways to even more dangerous building conditions. Disasters also require both temporary and permanent buildings for response and recovery. Additionally the skills, materials and resources necessary to build response and recovery buildings and shelters is nonexistent or in limited supply. The general building industry is fraught with many of these problems as well. The present invention embodies the design and construction of buildings, related building components, materials and methods, for, but not limited to, general building industry and disaster response, recovery, preparedness and mitigation, for temporary and permanent construction.

The present building system, by storing and shipping in stacks of light weight, flat panels, solves the problem of inefficient storage of emergency building assets for disaster preparedness (i.e., FEMA trailers), addresses slow recovery efforts with a system of fast deployment for response to the shelter requirements for businesses, government agencies, and survivors affected by disasters. Many logistics problems are solved by the building system, specifically but not limited to building quickly under adverse weather or disaster obstacles, with lack of electrical power or skilled construction labor force. The building is designed to be deployed and erected by limited skilled persons, some of whom may be survivors of a disaster, and having safety built into the methods and materials in that no worker need be off the ground more than about 3 or 4 ft to complete the building. The roof is completed without anyone having to get onto the roof. Further, delivery logistics problems due to obstructed routes for large trucks are solved due to the small overall size of the building package. The buildings can be brought to a site with a small truck, on the roof of a car or any other vehicle and even carried in by hand. Building construction generally requires a diverse array and large number of tools. The present building requires only a conventional manual material lift mechanism, cordless or corded screwdrivers and step ladders to construct the buildings. What is shown is a building assembly method and apparatus comprising a number of laminated panels of any shape and size with structural end caps of any shape size and thickness, connected by connector struts and hinged hub assembly permitting the building to be up and provide cover in as little as 2½ hours, with final installation of all connectors and fastening within a few hours. The building is Category 5 Hurricane and Earthquake resistant. The building may be temporary or permanent, can be disassembled to re-locate in 1 hour, with no worker off the ground more than 3 or 4 feet during construction. No cutting or tools are required beyond a manual material lift, cordless screw guns and a step ladder. Lightweight individual pieces can be handled easily by one or more persons.

### BRIEF SUMMARY OF THE INVENTION

The invention is a building having a plurality of vertically upright wall panels enclosing a defined space. The wall panels are linked together to form a stable structure. A plurality of roof panels cover the enclosed space and are affixed to the wall panels. Also included is a method of providing an emergency shelter. The method includes the steps of erecting a plurality of vertically upright wall panels to enclose a defined space. Then, the wall panels are linked together to form a stable structure. The method includes raising a plurality of roof panels over the defined space and fastening the roof panels to the wall panels.

Objects, advantages and novel features, and further scope of applicability of the present invention will be set forth in part in the detailed description to follow, taken in conjunction with the accompanying drawings FIGS. 1-11, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a perspective view of one configuration of the building.

FIG. 2 is a perspective view of another configuration of the building.

FIG. 3 is a cross section view of a wail panel of the building.

FIG. 4 is a cross section view of a roof component of the building.

FIG. 5 is a plan view of a roof hub assembly for the building.

FIG. 6 is a cross section view of the roof hub assembly and hub assembly lifter.

FIG. 7 is a perspective view of a panel connector strut.

FIG. 8 is an enlarged perspective view of the contact flange for the connector strut.

FIG. 9 is a perspective view of the connector struts in place on wall panels.

FIG. 10 is a perspective view showing the overlap of connector strut contact flanges.

FIG. 11 is a perspective view of a third configuration of the building.

### DETAILED DESCRIPTION OF THE INVENTION

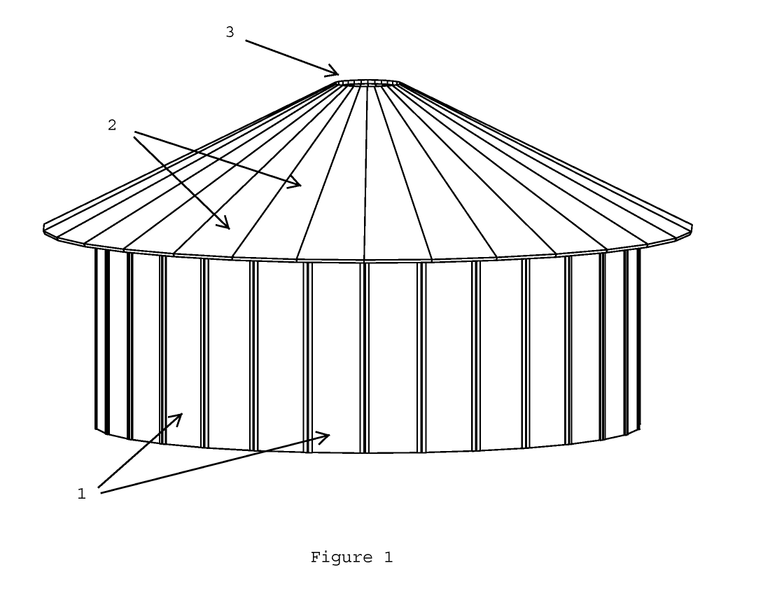

FIG. 1 is a perspective illustration of one of many possible shapes, designs or configurations of the panel building system herein using, in this illustration, a plurality of rectilinear, vertically upright, wall panels 1, placed in a circular configuration of any diameter, and a plurality of triangular, wedge shaped roof panels 2, to form a conical shape roof on a circular building floor plan. Vent hole/hub location 3 is shown in FIG. 1.

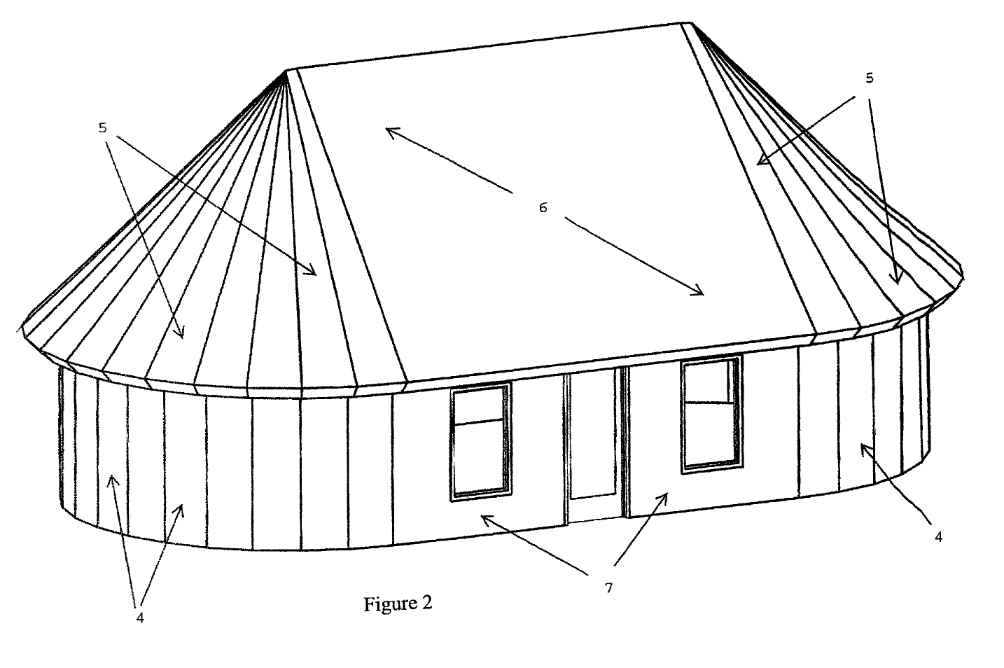

FIG. 2 is a perspective illustration of another configuration using the building system. In this illustration, a plurality of rectilinear wall panels 4, placed in a combination of rectilinear and circular configuration utilizing a plurality of triangular wedge shaped roof panels 5 to form a conical shape wall/roof, of any radius on two halves of a circular building floor plan, separated by rectilinear shaped roof assembly insert 6, of a given length or width, and rectilinear wall assembly insert 7, of a given length or width.

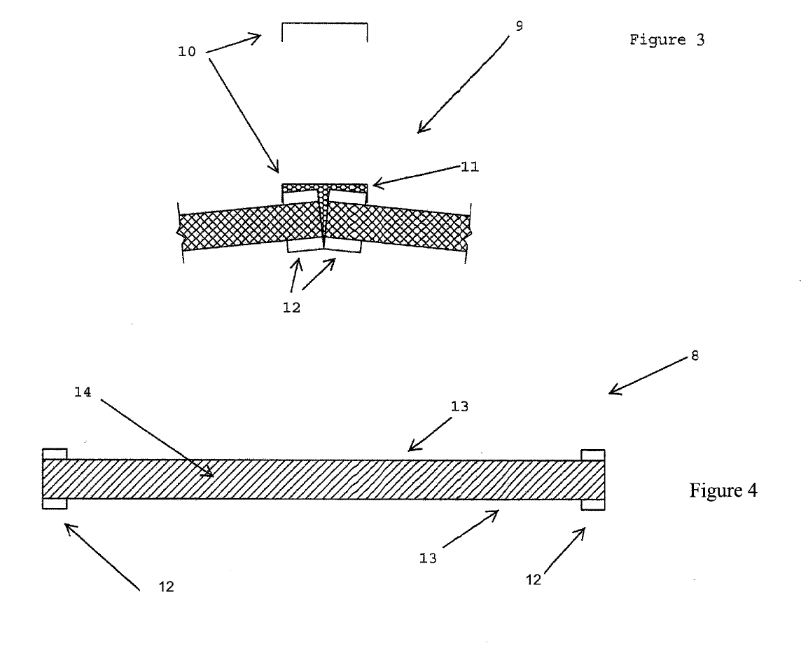

FIG. 3 is an illustration of wall panel 1 assembly 8. Panel assembly 8 includes exterior skin 13 covering panel insulation fill 14, completing the laminated panel assembly 8.

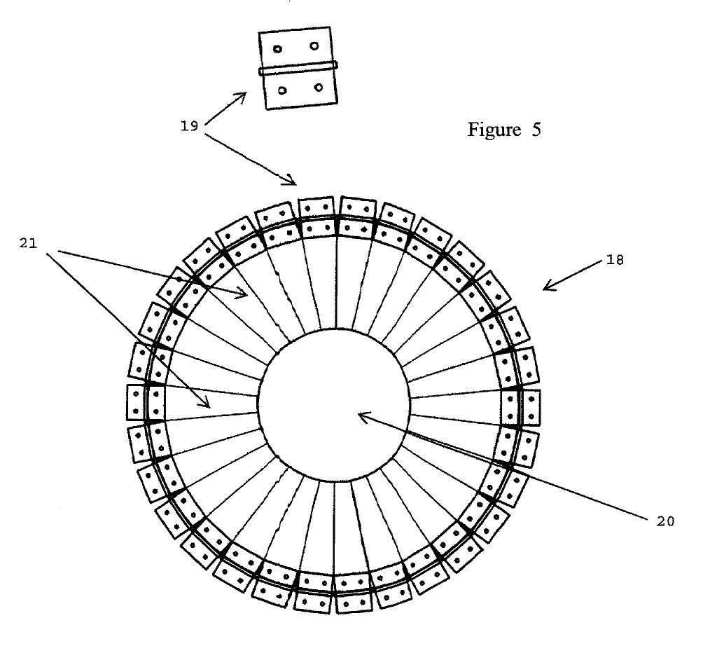

FIG. 4 is a cross section detail of a roof or wall panel connection 9, with cap flashing component 10, having insulation fill 11 under cap 10, including Structural C component wall end caps 12.

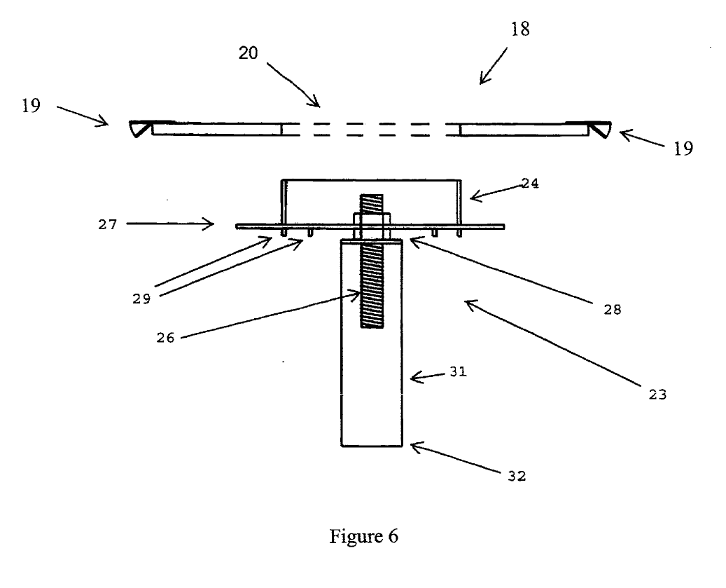

FIG. 5 is a plan view illustration of hub assembly 18. In this illustration, a circular arrangement, including a number of hinging mechanisms 19 is arranged in a polar or linear array, to affix roof panels 2 to hub assembly 18 by, but not limited to, fasteners such as adhesive, screws, bolts, weldment, or rivets, allowing a roof placement of any angle, with void 20 of any size or shape in the center as a vent hole and receptor for adapter hub sleeve 24 (see FIG. 6), necessary for lifting the hub and roof assembly to its final elevation and location. Layout lines 21 are provided for ease of alignment. Hub 18 may be left in place as part of final structure or removed if the panel fastening method allows. Embodying a plurality of hinging mechanisms 19 provides the ability to fasten all roof panels 2 in this building in proper alignment relative to the walls for a simultaneous lift of the roof assembly in its entirety to its final raised location, at any height or roof pitch angle, in as little as 30 seconds with the workers on the ground. Hinging hub assembly 18 also provides for the transfer of imposed and opposing forces in the roof assembly.

FIG. 6 is a cross section illustration of hub assembly 18, and hub adapter, 23, made of any material capable of supporting the necessary weigh and force of the assembly process. Also shown is sleeve 24 for insertion into hub assembly void 20. Threaded adjustment shaft 26 is provided with locking nuts or other locking device 28 to adjust elevation or rotation of hub assembly 18. Hub support platform 27 supports hub assembly 18 during placement and lifting of the roof/hub assembly and is fitted with sleeves 29 to mount laser pointers of any common size or brand for the purpose of aligning the roof panel apex and panel hinging mechanism 19 with the corresponding wall panel whereby the matching roof panel is properly aligned perpendicularly or otherwise to the wall panel at a predetermined angle or placement. Tube structure 31 of hub adapter 23 can be mounted on any material lifting equipment at attachment point 32, with a sleeve, flange, bolt(s), weldment, rivet(s), or any other fastening capable of withstanding the forces of lifting hub and roof assembly. Hub adapter 23, is designed to allow any material lifting system to safely and properly lift hinging hub assembly 18 and roof panels 2 and to adjust alignment of the system and subsequently easily removed after securing the roof and hub assembly in its final position.

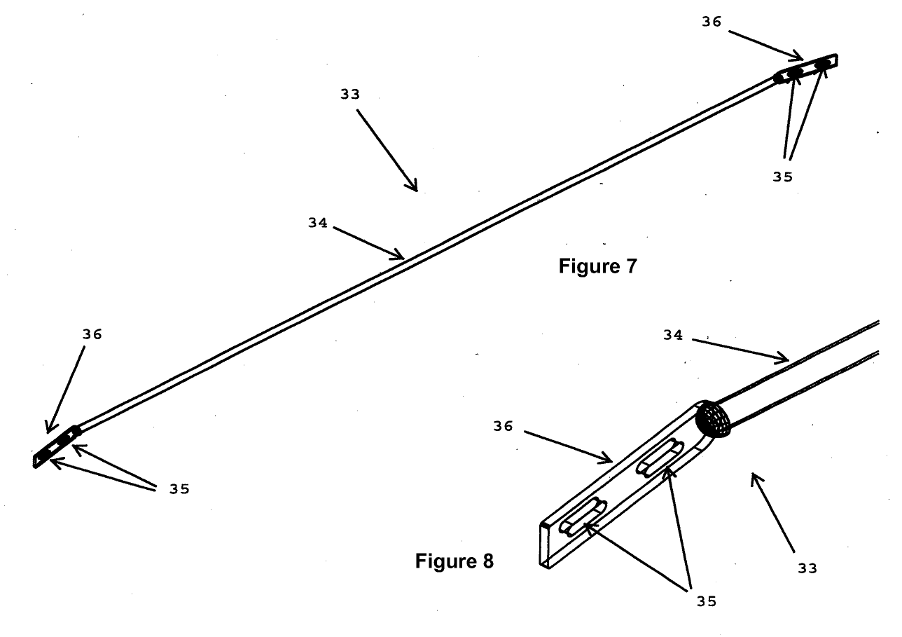

FIG. 7 is a perspective view of a stabilizer/connector strut shown 33, used to fasten wall and/or roof panels to each other at any angle and to be located at any elevation in any number, interior or exterior, for the purpose of registering panels to and with each other to create the floor plan shape of the building without the necessity to measure angles or distances. Once placed, connected and registered, tightening of fasteners of any type is completed to make a rigid structure. Strut 33 includes shaft 34 of a selected size, section shape or length, depending on the size and shape of the building. Registration slotted or drilled holes 35 are formed in contact flange or contact area 36. Flange 36 may be bent or straight to match the angle(s) or average angle of wall or roof panel assembly junctions.

FIG. 8 is an enlarged perspective view of stabilizer/connector strut 33, illustrating shaft 34, contact flange 36 and fastener/registration slots 35.

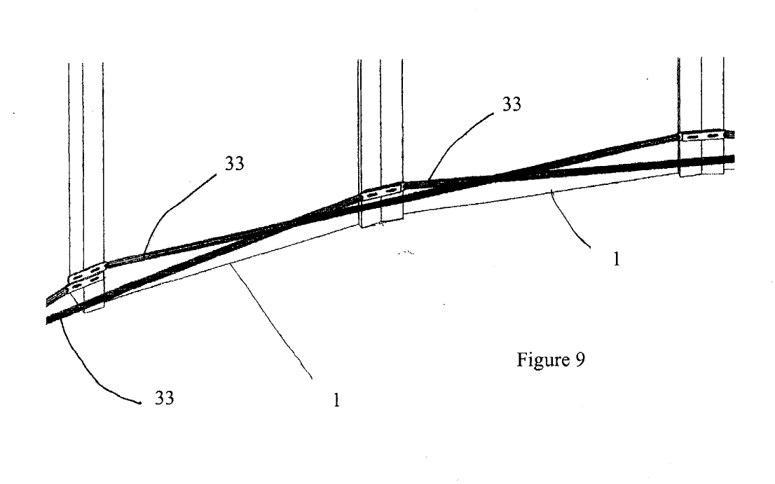

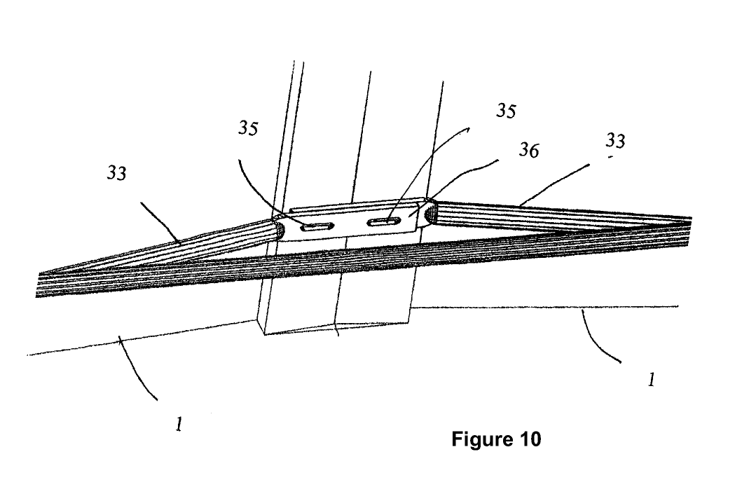

FIG. 9 is a perspective view showing connector struts 33 inner connecting wall panels 1. In FIG. 10, it can be seen that connector struts 33 overlap one another as do flanges 36 and their registration slots 35

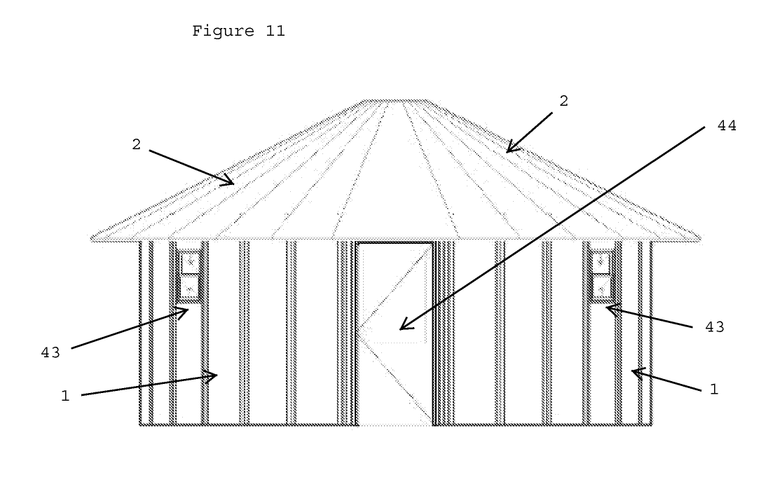

FIG. 11 is a perspective illustration of a possible building shape embodied by a plurality of wall panels 1 and roof panels 2, in a circular floor plan. This building includes a plurality of windows 43 and at least one door 44.

To assemble the building, as seen in FIG. 1 or FIG. 12, the site should be level or leveled prior to set up. Although not necessary, it is helpful to set up a center reference point prior to beginning. Setup can occur on a foundation, in a trench, on an elevated site, or on ground surface. A lifting mechanism affixed with hub adapter 23 and hinging hub assembly 18 is placed in the center of the building location. Erection of the walls is started by determining where door panel 44 will be located. Since it is the heaviest panel in the building, it is suggested but not necessary to stand it up first with braces, then start fastening 2 wall panels 1 together stabilizer/connector strut 33, at both top and bottom. Then, stand the assembled walls up and brace temporarily. If there is no wind, bracing is not necessary if subsequent panels are to be added right away and if a worker can keep a hand on the standing walls until more wall panels are added, using the same repeated sequence of wall placement and strut fastening. The more of the circle completed, the more stable the assembly.

A plurality of stabilizer/connector struts 33 are placed in an array alternating every other two panels at approximate top and bottom, of the wall assembly as walls are placed. Fasteners in registration slots 35 are only gently tightened until the entire wall assembly is complete and located properly and then all strut fasteners are tightened completely. A perforated compression strap is then applied to the outside top of wall assembly surrounding the building perimeter and fastened to each wall panel. The lifting mechanism is then positioned in proper position for lift of roof assembly 2 or 5, 6. Hub adapter 23 is then fitted with a laser pointing device in sleeves 29, under hub adapter platform 27 to align the hinging mechanism and roof panel apex precisely with its corresponding wall panel edge by rotating the assembly on threaded shaft 26 and locking into proper position using locking mechanism 28. This ensures the entire roof assembly will arrive at the top of the lift in the proper alignment so that adjustment of the entire weight will not be necessary.

A plurality of roof panels 2, with attached roof cap 10 on one side to mate with adjacent roof panel, are positioned singly or in multiples around the perimeter walls in the interior space with the exterior end of the roof panel leaning against the top of each corresponding wall panel, exterior facing in or up. Each roof panel is then lifted into alignment with corresponding hinging mechanisms 19 on hinging hub assembly 18 and fastened to the hinging mechanism with a number of fasteners.

Upon completion of fastening roof panels to hinging hub assembly, preassembled vent cap flashing 45 is affixed to the top of hinging hub assembly 18 arranged to overlap the apex of the assembled roof panels. The apex is then raised by the lifting mechanism affixed with hub adapter 23 atop and fitting to hinging hub assembly void 20. Lifting continues until the roof panels are in place at the proper elevation and abutting the adjacent roof panel for closure under roof cap 45, allowing the roof panels to be raised as a unit. After the roof assembly of panels 2 has been raised to its final location, workers then proceed to fasten roof panels 2 to corresponding wall panels 1 with angle clips, plates, or any other approved connector with drill screws or any other approved fastener.

Additional fasteners are placed in strut registration slots 35 at extreme ends of slots to prevent any movement and eliminate the ability for struts 33 to slide on the fasteners. Each roof panel is bolted or otherwise fastened to its adjacent roof panel. A worker or workers then fastens roof cap 10 from a step ladder or other working platform as far up on the roof as is practicable or easily reached. Lifting mechanism or equipment is then lowered and removed, leaving the completed roof with hinging hub assembly in place with the roof assembly at the proper height. No support of hub 18 is necessary after final fastening of all hinging mechanisms 19, struts 33, plates, connectors, straps, wall and roof caps 10, flashings 45 and panels 1, 2 or 4, 5, 6. Once completed, the building may be secured to a foundation by brackets or other hold down devices attached to wall panels 1.

To disassembly and relocation the building, reposition lifting mechanism affixed with hub adapter 23 under hinging hub assembly 18 and raise to the mating position with hub adapter sleeve 24 inserted into void 20 of hinging hub assembly 18. Then, raise the assembly until weight bearing and then in reverse order of the above sequence, remove roof fasteners, connectors plates cap flashing fasteners until the roof assembly is disconnected from the wall assembly, then lower to remove individual roof panels. The disassembly of the wall panels is the same. The door panel assembly should be braced, then remove panels/struts in sequence until all are removed. Stacking or palletizing for storage or relocation is accomplished as each roof and wall panel is removed. Struts and connectors and all miscellaneous parts are packaged or boxed to remain with the panel components.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A building comprising:
a plurality of vertically upright wall panels enclosing a space;
a plurality of connector struts linking said wall panels together to form a stable structure; and;
a plurality of roof panels covering said enclosed space and affixed to said wall panels.

2. The building of claim 1 wherein said connector struts comprise:
a shaft of a pre-selected size to allow said connector struts to overlap said wall panels;
a contact flange on each end of said connector struts; and
registration openings formed in each contact flange and positioned to contact said wall panels and align with registration openings in adjacent contact flanges.

3. The building of claim 1 further comprising at least one door formed in said wall panels.

4. The building of claim 1 further comprising at least one window formed in said wall panels.

5. The building of claim 1 wherein said wall panels comprise:
an insulating layer of material; and
an inner and an outer skin enclosing said insulating material.

6. The building of claim 1 wherein said roof panels comprise;
an insulating layer of material; and
an inner and an outer skin enclosing said insulating material.

7. The building of claim 1 wherein said enclosed space is circular and further comprising:
a hub assembly comprising a plurality of hinging mechanisms arrayed in a circular pattern corresponding to said enclosed space;
a plurality of fasteners connecting said hinging mechanism to said roof panels to allow said roof panels to be lifted in to place as a unit; and
a hub adapter for engagement with said hub assembly to lift said hub assembly and roof panels.

8. The building of claim 7 wherein said roof panels are triangular in shape.

9. The building of claim 8 wherein said roof panels are configured to leave an opening where they meet for insertion of said hub adaptor.

10. The building of claim 9 further comprising a cap to cover said opening once said roof is completed.

11. A method for providing emergency shelter comprising the steps of:
erecting a plurality of vertically upright wall panels to enclose a defined space;
linking said wall panels together to form a stable structure;
raising a plurality of roof panels over said defined space; and
fastening said roof panels to said wall panels.

12. The method of claim 11 further including the step of forming a door in at least one of said wall panels.

13. The method of claim 11 further including the step of forming a window in at least one of said wall panels.

14. The method of claim 11 wherein the step of raising a plurality of roof panels includes the steps of:
attaching said roof panels to a hinging mechanism; and
lifting said hinging mechanism carrying said roof panels to a position overlying said defined space.

15. The method of claim 14 wherein said emergency shelter is circular and wherein the step of attaching said roof panel to a hinging mechanism comprises the steps of:
arraying a plurality of hinging mechanisms in a circular array;
fastening said roof panels to said circular array of hinging mechanisms;
leaving a void where said roof panels do not meet; and
lifting said roof panels and said hinging mechanism to form a roof over said enclosed space.

16. The method of claim 15 further comprising the step of covering said void after said roof panels are lifted into place.
